(19) United States
(12) Patent Application Publication
(10) Pub. No.: US 2015/0068534 A1
(43) Pub. Date: Mar. 12, 2015

(54) Apparatus for Immobilizing and Positioning a Patient's Hand

(71) Applicants: Lawrence Lubbers, Columbus, OH (US); Lori Brown, Boerne, TX (US)

(72) Inventors: Lawrence Lubbers, Columbus, OH (US); Lori Brown, Boerne, TX (US)

(21) Appl. No.: 14/022,620

(22) Filed: Sep. 10, 2013

(51) Int. Cl. A61G 13/12

(52) U.S. Cl. CPC A61G 13/124; A61G 13/1285
USPC 128/845

(57) ABSTRACT

A hand positioner for holding a hand in a desired position during surgical procedures. The hand positioner includes a central body, digital tabs corresponding generally to the fingers and thumb, a plurality of elevating tabs, and a plurality of positioning tabs for selectively elevating and supporting areas of the hand. The inner layer of the positioner being made of a material with sufficient plasticity to bend under an applied load and to remain bent when said applied load is removed, and having a layer of cushioning material on both sides of the inner layer.

### FIELD OF THE INVENTION

The present invention is directed to an apparatus for positioning a person's hand. In particular, the present invention is directed to an apparatus for positioning and immobilizing a patient's hand during a surgical procedure.

### BACKGROUND OF THE INVENTION

Hand immobilizers are often used in surgical procedures. When a patient is given anesthesia for purposes of an operation, various physiological reactions occur. One such reaction is that the patient's hands will close up or clench. This is particularly a problem when the surgical procedure is to be performed on the hand. Consequently, hand immobilizers are used to keep the hands in an open position.

Hand immobilizers are formed generally in the shape of a hand, having digit elements sufficiently long enough to be bent over the tips or ends of the patient's digits and thus hold them in the open position. One example of a common hand immobilizer is seen in U.S. Pat. No. 5,560,375, incorporated herein by reference for all purposes. Hand immobilizers are often made from a flexible metal such as aluminum and may or may not include some form of cushion layer atop the metal.

While prior art hand immobilizers are used for holding the hand in an open, palms-up position, they are not able to form the hand to other positions. For example, if a surgeon needs to operate on a side of the hand or on one side of one finger, the prior art immobilizer would not be useful in providing the surgeon access to the desired location. Instead, the surgeon would designate an assistant to position and hold the patient's hand in the required position. The present invention is directed to an improved hand immobilizer which also provides hand positioning capability.

### SUMMARY OF THE INVENTION

In one aspect, the present invention provides an apparatus for holding a hand in a desired position during surgical procedures.

In another aspect, the present invention provides an apparatus for elevating portions of the hand during surgical procedures.

These and further features and advantages of the present invention will become apparent from the following detailed description, wherein reference is made to the figures in the accompanying drawings.

### BRIEF DESCRIPTION OF THE DRAWINGS

FIG. 1 is a front, plan view of one embodiment of the hand positioner present invention.

FIG. 2 is a cross-sectional view taken along the lines 2-2 of FIG. 1.

FIG. 3 is a front, plan view of another embodiment of the present invention.

FIG. 4 is an environmental view of the present invention showing the hand positioner positioning the hand for one type of surgical procedure.

FIG. 5 is another environmental view of another embodiment of the present invention showing the hand positioner positioning the hand for another type of surgical procedure.

FIG. 6 is yet another environmental view of the present invention, showing the hand position of FIG. 5 from another angle.

FIG. 7 is a further environmental view of the present invention showing the hand positioner positioning the hand for another type of surgical procedure.

FIG. 8 is a still further environmental view of the present invention showing the hand positioner positioning the hand for still another type of surgical procedure.

FIG. 9 is an environmental view of the present invention showing the hand positioner positioning the hand for yet another type of surgical procedure.

### DETAILED DESCRIPTION OF PREFERRED EMBODIMENTS

The term “plasiticity” or “plastic” as used herein means pliable or deformable such that the item or portion so identified may be bent or moved to one position and it will remain in that position without springing back to its original position until a load is applied. Thus, the item or portion may be subsequently bent again into yet another position or to its original position as needed.

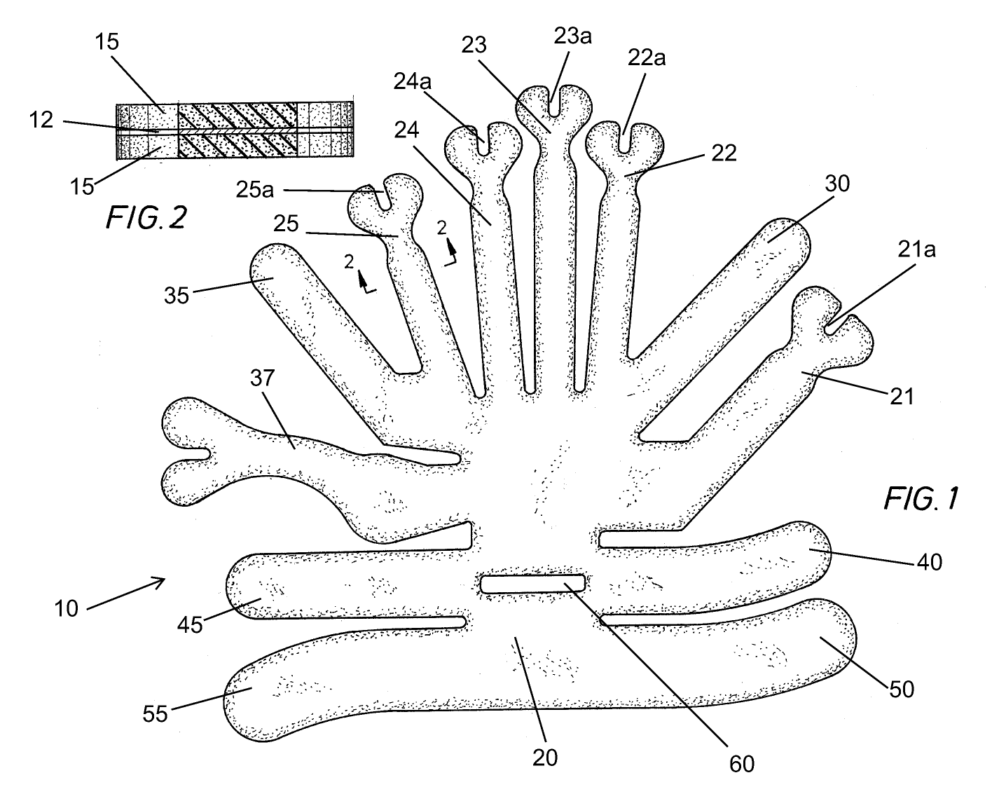

Turning to the figures, FIG. 1 shows a front view of one embodiment of the present invention, shown generally as 10. Central body 20 is shaped to generally engage the metacarpus, wrist and forearm of the patient. Digital tabs 21, 22, 23, 24, and 25 extend from said central body portion and are positioned such that they generally correspond to the position of the thumb and fingers, respectively, when the hand is laid flat on the positioner 10 with the palm facing up. In a preferred embodiment, the peripherally outermost ends or tips of digital tabs 21-25 are split by notches 21a, 22a, 23a, 24a, and 25a, respectively, to form spaced grasping appendages.

A pair of elevating tabs 30 and 35 extend from central body 20. In a preferred embodiment elevating tab 30 is positioned between digital tabs 21 and 22, and elevating tab 35 is positioned laterally to digital tab 25. It will be appreciated that the present invention is not intended to limit the positioning of the tabs. Elevating tabs 30 and 35 may be positioned in any number of locations and still be within the scope of the invention. Elevating tabs 30 and 35 are used to selectively elevate areas of the hand positioner and will be discussed more fully hereafter. Two pairs of positioning tabs 40, 45, 50 and 55 are shown at the lower end of the central body 20. As will be seen hereafter, positioning tabs 40, 45, 50, and 55 are used to selectively provide elevation or to selectively support portions of the hand, wrist, or forearm as needed. A palmar restraint 37 is positioned between elevating tab 35 and positioning tab 45. It will be appreciated that FIG. 1 represents a preferred embodiment of the present invention. Alternative embodiments may have fewer positioning tabs and may see fit to omit the palmar restraint 37. Nonetheless, such embodiments are contemplated within the scope of this invention.

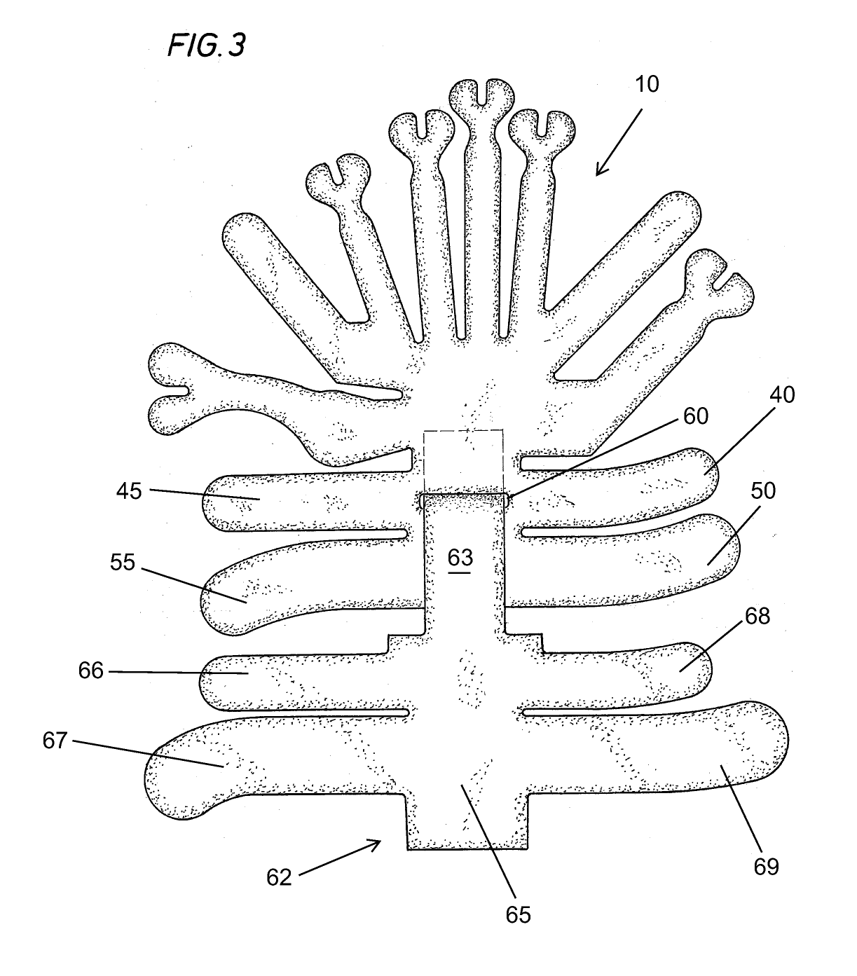

In a preferred embodiment, body 20 includes slot 60, sized for selectively, removably receiving a connecting tab 63 of an auxiliary positioner 62, shown in FIG. 3. Auxiliary positioner 62 includes body 65 and has a plurality of extension tabs 66, 67, 68, and 69. Extension tabs 66, 67, 68, and 69 are used to selectively elevate or position the forearm as needed. It will be appreciated that while the embodiment shown in FIG. 3 includes 4 tabs, auxiliary positioner 62 can be sized to hold any number of extension tabs as needed. Connecting tab 63 is received in slot 60 of hand positioner 10 and may be used to position auxiliary positioner 62 as close to hand positioner 10 as needed by sliding connecting tab 63 further into slot 60.

FIG. 2 shows the cross-section of digital tab 25 of the hand positioner 10 of the present invention and is representative of the general cross-section of hand positioner 10. Hand positioner 10 is made of a thin layer 12 of material, such as aluminum or the like, which has sufficient plasticity such that portions of hand positioner 10 may be bent into a desired position and the bent portions will hold their position after being bent until an applied load or force of sufficient magnitude moves it back to the original or to another position. Such materials have the flexibility to be maneuvered into a virtually limitless number of positions but the strength to maintain the position even with the added weight of a patient's hand and forearm atop the hand positioner. As shown in FIG. 2 both sides of the inner layer 12 are covered with a cushioning material 15. It will be appreciated that the cushioning material 15 can be present on only one side of the inner layer 12 or omitted completely as desired. With or without cushioning on both sides, the hand positioner 10 can be used to position either the left or the right hand. The surgeon need only turn the hand positioner to the correct side.

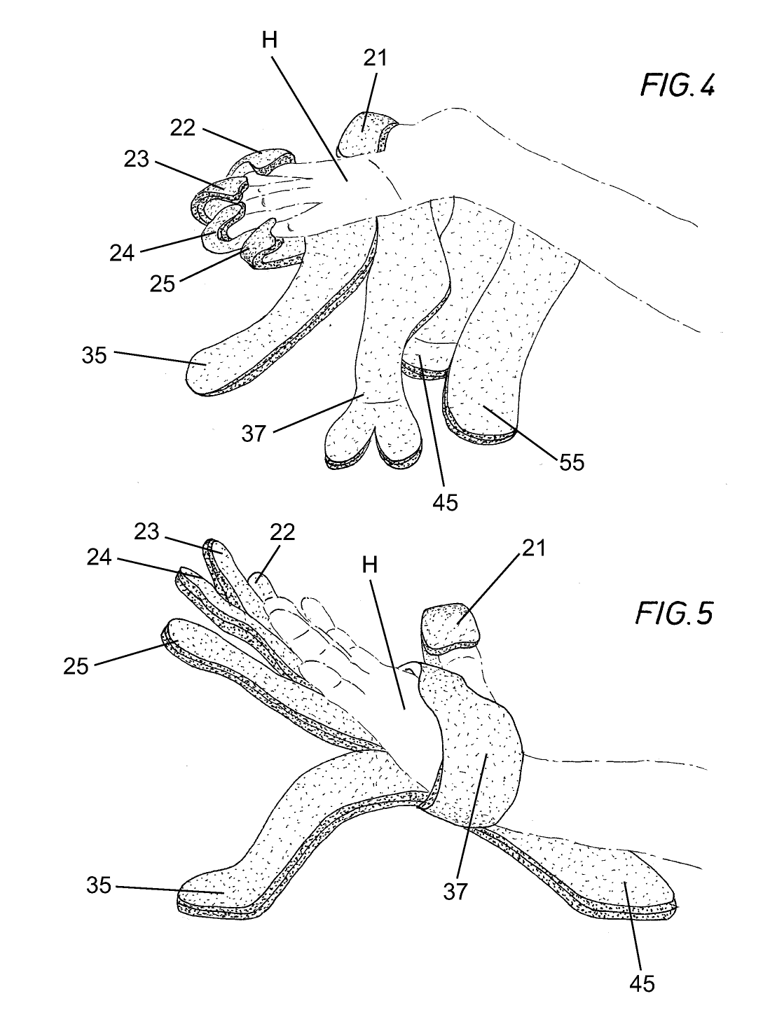

FIG. 4 shows an environmental view of one embodiment of the present invention. In FIG. 4, the patient's hand H is palm up and the digital tabs 21-25 are bent over the ends or tips of fingers and thumb. Elevation tabs 35 (and 30, not seen at this angle) and positioning tabs 45, 55 (and 40 and 50, not seen at this angle) are used to elevate and position the hand and the wrist. The central body portion 20 is also bent slightly to better support the palm and distal forearm/wrist. This positions the hand with the wrist in extension to allow the surgeon to access the palmar and thenar regions of the hand. Specifically, there is excellent access to the superficial arch, common digital arteries, nerves, carpal tunnel, and Guyon's canal.

FIG. 5 shows an environmental view of another embodiment of the present invention. In this embodiment, digital tabs 21-25 lack of notches 21a-25a. In the position shown in FIG. 5, the fingers are supported on digital tabs 22-25 but the fingers are not gripped. Only the thumb is supported by and gripped by digital tab 21. Palmar restraint 37 extends across the palm of hand H. Elevating tabs 35 and 40 elevate the hand positioner. Positioning tabs 40, 45, 50, and 55 remain extended out. This embodiment illustrates how some of the tabs may not be required to achieve certain positions but may instead simply be left to extend outwards. As shown in FIG. 5, wrist flexion can be controlled by using only the elevating tabs 30 (not seen at this angle) and 35 and the palmar restraint 37. This position provides access to the phalanges.

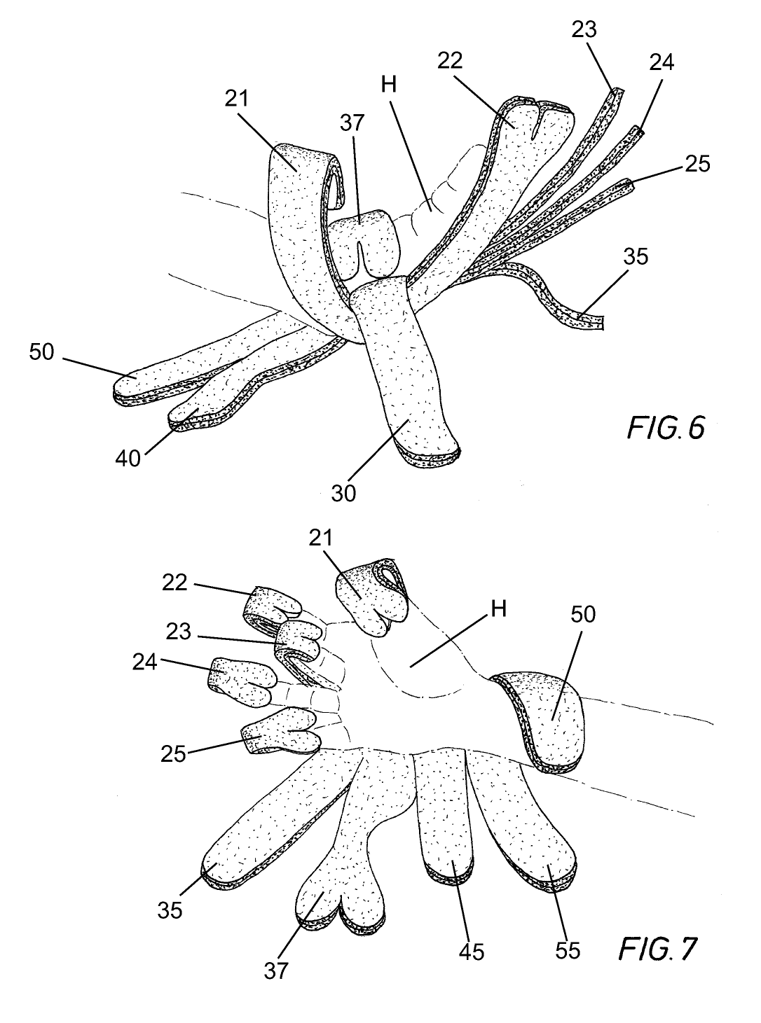

FIG. 6 is similar to the hand position shown in FIG. 5 but shown from the opposite side and with the thumb at angle relative to the fingers. As seen, elevating tabs 30 and 35 control the wrist flexion. Palmar restraint 37 holds the palm in place at the first web and digital tab 21 holds the thumb. The remaining digital tabs support to the fingers without gripping them. The position shown in FIG. 6 demonstrates how the hand can be positioned in varying degrees of flexion.

FIG. 7 shows the hand positioner of the present invention with the palm of the patient's hand H facing sideways. In this position, all the digital tabs are gripping and positioning the fingers and thumb. The position of FIG. 7 places the fingers in an exact position needed to achieve the required shaping of the palm. Such precise placement of the hand is not possible with prior art hand immobilizers. Elevating tab 35, palmar restraint 37 and positioning tabs 45 and 55 are not required for this position and are simply left to lie flat. Positioning tab 50 is used to hold the wrist at the desired angle. This position facilitates the surgeon's direct visualization of the deep palmar structures.

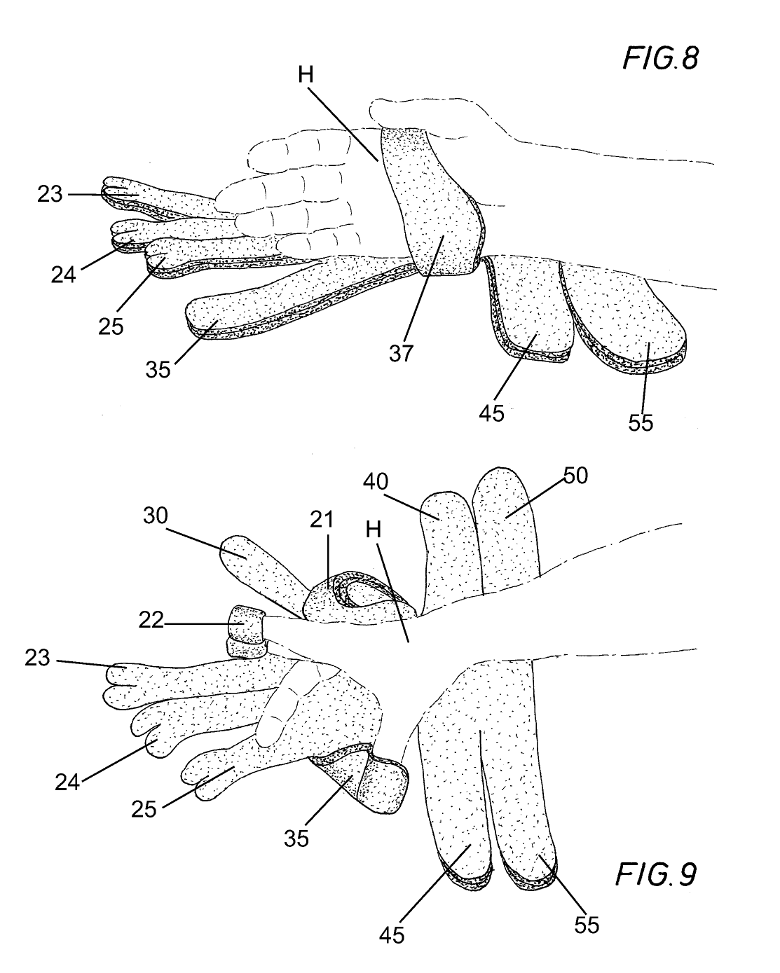

FIG. 8 shows another position in which the palm faces the surgeon. However, unlike in FIG. 7, only the palmar restraint is used to hold the hand H in position. The remaining tabs are all left flat. In this position, the surgeon has easy access to the first dorsal compartment of the wrist at the base of the thumb for the relief of DeQuervain's tenosyneovitis.

FIG. 9 shows yet another position using the hand positioner of the present invention. FIG. 9 demonstrates how elevating tab 35 can be used, when necessary, to position and grip the digits of the patient's hand H. In this case, elevating tab 35 is used to hold the patient's thumb. Digital tab 22 is used to hold multiple fingers of the patient and digital tab 21 provides support to the back of the hand. This position provides the surgeon with easy access to the first web of the hand as well as the snuff box and radial artery. The position of FIG. 9 best demonstrates the utility of the present invention by illustrating how the tabs intended for elevation can serve to support and grip the digits while the tabs intended to support and grip the digits can instead provide support to the metacarpus.

It will be readily appreciated that the hand positions shown in FIGS. 4-9 encompass only a small sampling of the myriad of hand positions attainable with the hand positioner of the present invention. The hand positioner of the present invention can position and maintain the hand, wrist and forearm, in flexion, extension, pronation, and supination. Without wanting to be limited, the following examples demonstrate some of the additional positions which can be achieved using the hand positioner of the present invention:
position the hand and forearm flat, palm up and use only the digital tabs to hold each of the fingers and thumb flat in complete extension;
position the hand and forearm, palm up, hold the fingers open and flat, hold the thumb in an upward position for flexor pollicis longus muscle repair, digital nerve, or artery repair;
position the hand and forearm, palm up, hold one or more of the fingers in an upward position, hold the remaining fingers and thumb flat for flexion digitorum profundus and sublimus tendon repair;
position the hand and forearm palm down, elevate the palm so the hand is bent at the wrist, hold the fingers and thumb straight, with fingers splayed or with fingers together for thumb extension repair or extensor muscle/tendon repairs;
position the hand and forearm palm down, elevate the palm so the hand is bent at the wrist, curl the thumb, index finger and middle finger while holding the ring finger and little finger straight;
position the hand and forearm palm down, elevate the palm so the hand is bent at the wrist, curl all the fingers and thumb for surgery on the extensor pollicis longus muscle;
position the hand and forearm palm down, do not elevate the palm but keep the hand relatively straight at the wrist, curl all the fingers and thumb for surgery on the dorsal ganglion or to access metacarpal fractures;
rest the hand palm down, curl the palmar restraint around the web to hold the hand in mild pronation for dorsal thumb reconstruction; and
position the hand on its side with the thumb up for dorsoradial forearm and thumb access.

It will be appreciated that the hand positioner of the present invention can be used in surgeries of the hand, wrist, mid forearm, and distal forearm.

Although specific embodiments of the invention have been described herein in some detail, this has been done solely for the purposes of explaining the various aspects of the invention, and is not intended to limit the scope of the invention as defined in the claims which follow. Those skilled in the art will understand that the embodiment shown and described is exemplary, and various other substitutions, alterations and modifications, including but not limited to those design alternatives specifically discussed herein, may be made in the practice of the invention without departing from its scope.

What is claimed is:

1. A hand positioner for use in hand surgery, comprising:
a central body portion adapted to engage the metacarpus;
five digital tabs extending laterally outwardly from said body portion for selectively grasping at least one of said fingers and thumb, wherein said digital tabs comprise a thumb tab, an index finger tab, a middle finger tab, a fourth finger tab, and a little finger tab;
first and second elevating tabs extending laterally outwardly from said body portion for selectively elevating at least a portion of said hand positioner proximal said first and second elevating tabs;
said hand positioner being of a material being sufficiently plastic to bend under an applied load and to remain bent when said applied load is removed

2. The hand positioner of claim 1, wherein said first elevating tab is positioned between said thumb tab and said index finger tab, and said second elevating tab is positioned laterally outside said little finger tab.

3. The hand positioner of claim 1, further comprising:
first and second wrist tabs extending laterally from opposite sides of said central body portion.

4. The hand positioner of claim 1, further comprising:
a palm support tab extending laterally from said body portion.

5. The hand positioner of claim 4, wherein said palm support tab is positioned opposite the thumb tab.

6. The hand positioner of claim 1, further comprising:
third and fourth elevating tabs extending laterally outwardly from said body portion for selectively elevating the area of said hand positioner proximal said third and fourth elevating tabs.

7. The hand positioner of claim 1, wherein the peripherally outermost end of each of said digital tabs include a notch.

8. The hand positioner of claim 1, further comprising:
an opening in said central body portion for receiving an extension of said central body portion;
said extension comprising a plurality of lateral tabs for selectively positioning or elevating the wrist and arm.

9. The hand positioner of claim 1, further comprising a layer of cushioning material covering one side of said hand positioner.

10. The hand positioner of claim 9, further comprising a layer of cushioning material covering the other side of said hand positioner.
